(19) United States
(12) Patent Application Publication
(10) Pub. No.: US 2011/0127200 A1
(43) Pub. Date: Jun. 2, 2011

(54) GARMENT SORTING SYSTEM FOR CLEANERS

(76) Inventor: Young H. Han, Denver, CO (US)

(21) Appl. No.: 12/947,509

(22) Filed: Nov. 16, 2010

Related U.S. Application Data
(60) Provisional application No. 61/264,961, filed on Nov. 30, 2009.

(51) Int. Cl. B07C 5/00; B07C 5/02

(52) U.S. Cl. 209/3.3; 209/552

(57) ABSTRACT

A garment sorting system for cleaners dynamically adjusts the width of the window on a sorting conveyor assigned to each customer order based on the number of garments in the order. A computer logs in each customer order, prints identification tags for each garment, and stores data concerning the number of garments. A sorting conveyor controlled by the computer has a connected series of window segments for hanging garments, and a sorting station with an identification tag reader and an adjustable shutter mechanism. After cleaned, an operator scans the identification tag for each garment. The computer retrieves the associated customer order information, rotates the sorting conveyor so that the set of window segments associated with the order for that garment is aligned with the sorting station, and adjusts the aperture of the shutter mechanism to expose the window segments that have been allocated for that order.

### RELATED APPLICATION

The present application is based on and claims priority to the Applicant's U.S. Provisional Patent Application 61/264,961, entitled “Garment Sorting System For Cleaners,” filed on Nov. 30, 2009.

### BACKGROUND OF THE INVENTION

1. Field of the Invention

The present invention relates generally to the field of garment sorting systems for cleaners. More specifically, the present invention discloses a garment sorting system that enables the portion of the conveyor allocated for each customer order to be dynamically adjusted based on the number of garments in the customer order.

2. Statement of the Problem

For the purposes of this application, the term “cleaner” should be broadly construed to include dry cleaners, laundries, and other kinds of professional cleaners that clean garments or similar items on behalf of their customers. Many cleaners employ computer systems to track and manage customer orders. For example, a customer may walk into a cleaner with a number of garments to be cleaned. The cleaner typically logs the order into the computer system so that each garment in the order will be associated with the customer. The computer system prints identification tags (e.g., bar codes with adhesive backing) that are attached to each garment to enable the garments to be associated with the appropriate customer order.

Large numbers of garments from many client orders are then commingled for cleaning in batches. After cleaning is complete, the commingled garments must be sorted by customer order, as indicated by their identification tags, so that the correct garments can be returned to each customer. For example, the garments in each batch can be manually sorted by their identification tags.

Many cleaners employ a rotating conveyor as a hanging rack to assist in this sorting process. The conveyor has a connected series of window segments that can be allocated to hanging garments by their customer orders. Each window segment has at least one opening with a rail or cross-piece extending along its bottom edge for supporting a garment on a conventional hanger. These window segments are often numbered to assist the operator in the sorting process. In particular, the operator hangs each garment in the numbered window segment matching the number found on that garment's identification tag. The operator actuates manual controls to rotate the conveyor until the desired window segment for hanging each garment is in front of the operator.

This process has also been computerized by incorporating a bar code reader to scan the identification tag on each garment. The computer system assigns a window segment for each customer order. The computer automatically rotates the conveyor so that the appropriate window segment is in front of the operator for each garment. This helps to eliminate operator error in sorting garments.

Many computerized systems also include a fixed aperture mounted to the frame of the conveyor in front of the operator at the sorting station to clearly define the correct window segment for hanging each garment. This frame often has left and right vertical members that are spaced apart from one another by a horizontal distance roughly corresponding to the width of one of the window segments on the conveyor. Thus, the operator is presented with one, and only one window segment on the conveyor at any given time while sorting garments. This aperture further helps to eliminate operator error.

One shortcoming of the prior art in this field is that the size of the window segment allocated to each customer order is fixed. This creates a particular problem in the case of a customer order that is too large to fit within a window segment. It also causes under-utilization of the storage capacity of the conveyor in the case of small customer orders.

3. Solution to the Problem

The present invention addresses this shortcoming in the prior art by providing a garment sorting system that can dynamically adjust the width of the window on the conveyor assigned to each customer order based on the number of garments in the order.

### SUMMARY OF THE INVENTION

This invention provides a garment sorting system for cleaners that dynamically adjusts the width of the window on a sorting conveyor assigned to each customer order based on the number of garments in the order. A computer is employed to log in each customer order, print identification tags for each garment, and store data concerning the number of garments and their characteristics for each customer order. The present system also includes a sorting conveyor controlled by the computer having a connected series of window segments for hanging garments, and a sorting station with an identification tag reader and an adjustable shutter mechanism between the conveyor and sorting station that is controlled by the computer. After a batch of garments have been cleaned, the commingled garments are sorted by an operator at the sorting station who scans the identification tag on each garment. For each garment, the computer retrieves the associated customer order information based its identification tag. The computer rotates the sorting conveyor so that the appropriate set of window segments associated with the customer order for that garment is aligned with the sorting station, and adjusts the aperture width of the shutter mechanism to expose to the operator the window segments on the sorting conveyor that have been allocated for the customer order associated with that garment. For example, the number of allocated window segments on the conveyor and the corresponding aperture width of the shutter mechanism for each customer order can be determined by the computer based on the number of garments in the customer order, or as a function of the number and type of garments in the customer order.

These and other advantages, features, and objects of the present invention will be more readily understood in view of the following detailed description and the drawings.

### BRIEF DESCRIPTION OF THE DRAWINGS

The present invention can be more readily understood in conjunction with the accompanying drawings, in which:

FIG. 1 is a block diagram of the present system.

FIG. 2 is a flowchart of the steps in the using the present system.

FIG. 3 is a side elevational view of the shutter mechanism and a portion of the sorting conveyor with the aperture width set to expose one window segment.

FIG. 4 is a side elevational view of the shutter mechanism and a portion of the sorting conveyor with the aperture width set to expose two window segments.

FIG. 5 is a side elevational view of the shutter mechanism and a portion of the sorting conveyor with the aperture width set to expose three window segments.

FIG. 6 is a cross-sectional view of the sorting conveyor and shutter mechanism.

### DETAILED DESCRIPTION OF THE INVENTION

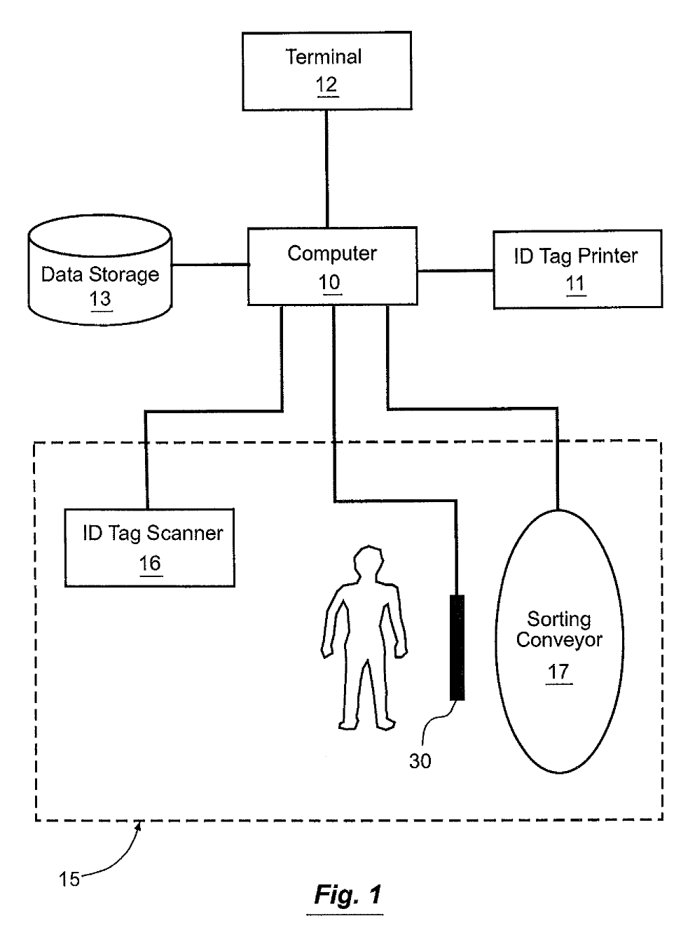

Turning to FIG. 1, a block diagram is provided showing one embodiment of the present invention. The first of the major components of the present system is a computer 10 with an associated data storage unit 13 (e.g., a hard disk or flash disk), a terminal 12 for user input (e.g. a display, keyboard and mouse), and a printer 11 suitable for printing identification tags (e.g., bar codes with adhesive backing) for garments. For example, the computer 10, terminal 12, data storage unit 13 and printer 11 could be any conventional computer system and peripherals that are commonly used by many commercial cleaners. However, software modifications and additional hardware are necessary to interface to the components of the sorting station 15, as will be described below.

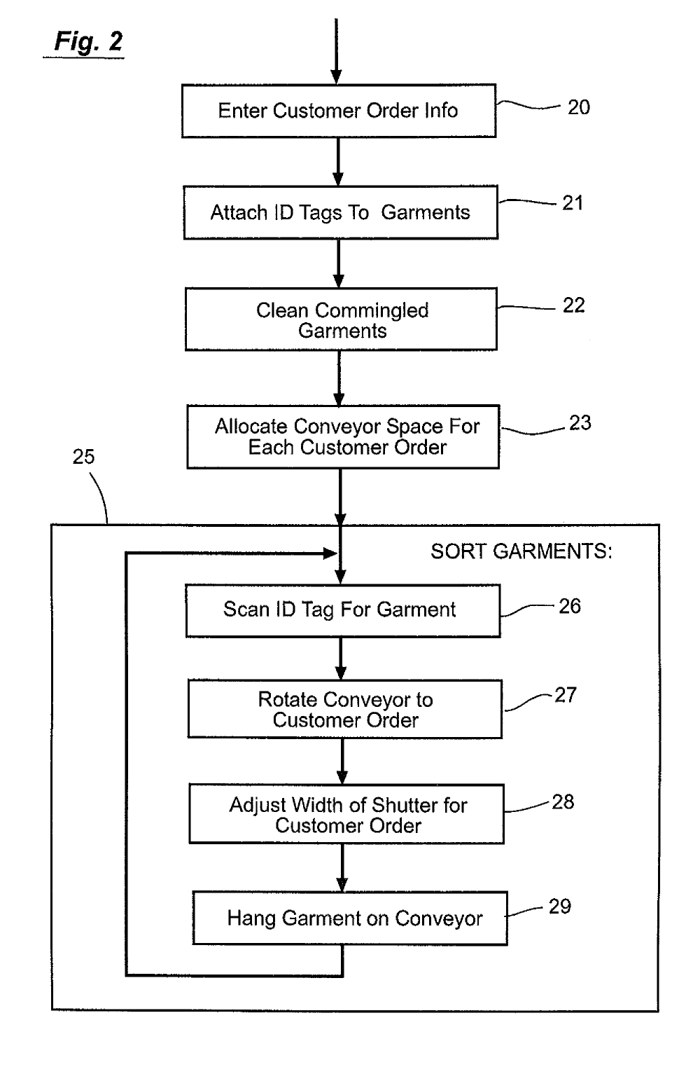

A corresponding flow chart of the steps in using the present invention is illustrated in FIG. 2. In step 20, information regarding a customer order is entered into the computer 10. This can include the customer's name, other identifying information, billing information, and information concerning the number and types of garments to be cleaned. A unique customer order identifier may be assigned to the order. All of this information can be stored in a database on the data storage unit 13 for later retrieval. In step 21, the computer directs the printer 11 to print identification tags that can be attached to each of the garments in the order. For example, if the customer has dropped off eight garments, the printer 11 will be instructed by the computer 10 to print eight bar codes tags bearing the customer order identifier for that order. Other information can be included in the identification tags, if needed. One of these tags is attached to each of the garment so that the garments can be tracked during processing and returned to the appropriate customer. After tagging, the garments can be commingled with other garments and cleaned as part of a larger batch of garments from multiple orders (step 22 in FIG. 2).

In step 23 in FIG. 2, the computer 10 analyzes the stored data for each customer order in the batch and allocates a section of the sorting conveyor 17 for each customer order. This can be done simply based on the number of garments in each customer order, or it can be done as a function of both the number and types of garments in each customer order. For example, coats or other types of bulky garments may require extra space on the sorting conveyor.

After each batch of garments has been cleaned, the garments must be sorted by customer order so that the appropriate garments can be returned to each customer (step 25 in FIG. 2). This sorting is done manually by an operator at the sorting station 15 shown in FIG. 1. The major components of the sorting station 15, as illustrated in FIG. 1, include sorting conveyor 17 and a scanner 16 (e.g., a bar code reader) that communicates with the computer 10. Similar to conventional sorting conveyors, the sorting conveyor 17 used in the present invention can have a connected horizontal series of window segments 18 that rotate about an oval track. More generally, the sorting conveyor 17 can be viewed as having a series of window segments 18 that can be moved along a track relative to the sorting station 15 under the control of the computer 10. For example, each window segment 18 has an opening with a cross-piece extending along its bottom edge for supporting a garment on a conventional hanger. The rotational position of the sorting conveyor 17 is driven by an electrical motor controlled by the computer 10. This enables the computer 10 to control which of the window segments 18 face the operator at the sorting station 15.

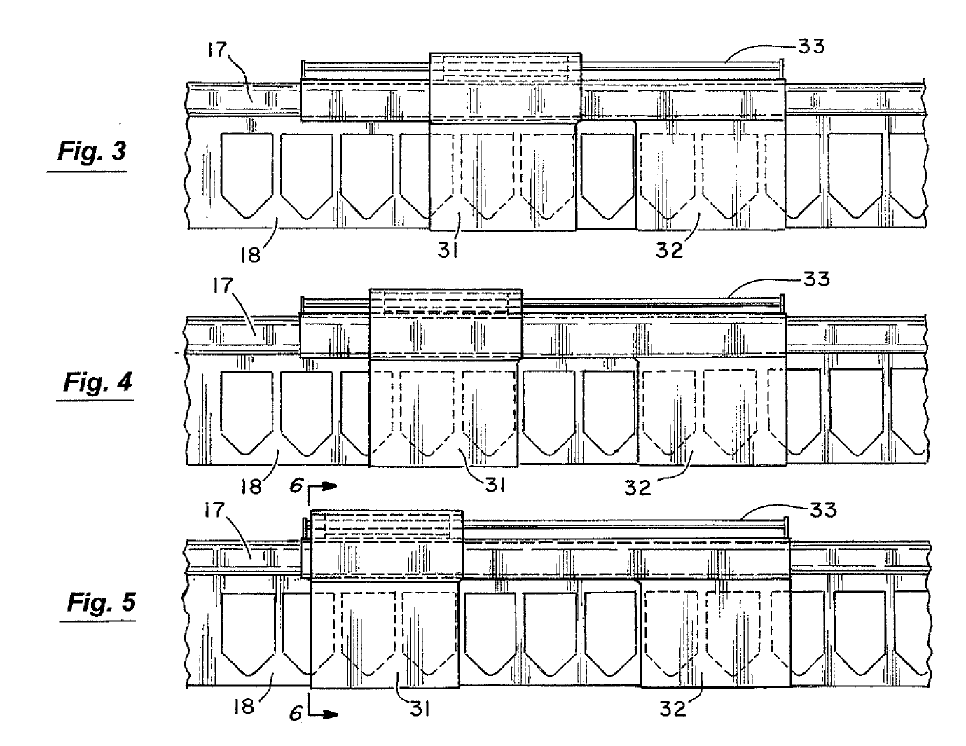

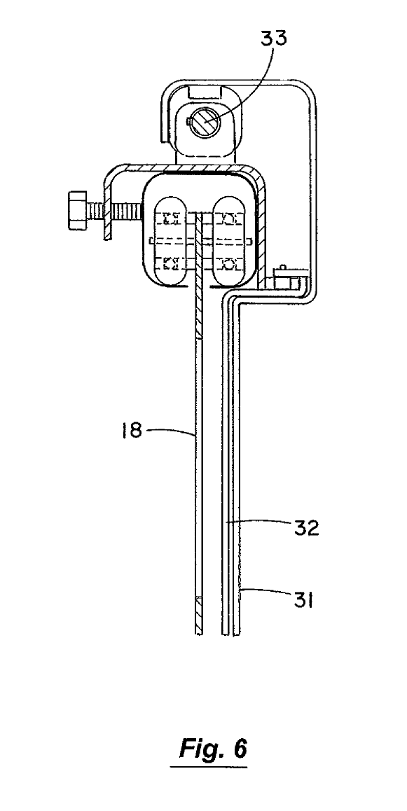

The sorting station 15 also includes an adjustable shutter mechanism 30 adjacent to the sorting conveyor 17 that is aligned with the operator's field of view so that a selected set of window segments are visible to the operator between two vertical shutters 31 and 32. The position of the shutters 31 and 32, and therefore the width of the aperture between the shutters is adjusted by a motor under the control of the computer 10 to expose a desired section of the sorting conveyor 17 to the operator. For example in this embodiment, the left shutter 31 slides along a guide rod 33 mounted to the right shutter 32. The right shutter is affixed to the frame of the conveyor 17 and does not move. The position of the left shutter 31 is driven by a motor or actuator controlled by the computer 10. Other shutter configurations and drive mechanisms could be substituted. FIGS. 3-5 show the shutter mechanism 30 and a portion of the sorting conveyor 17 with the aperture width set to expose one, two or three window segments, respectively. FIG. 6 is a cross-sectional view of the sorting conveyor 17 and shutter mechanism 30.

Returning to the flowchart in FIG. 2, the operator scans the identification tag on each garment, which enables to the computer 10 to identify the customer order for the garment (step 26 in FIG. 2). In step 27, the computer 10 directs the sorting conveyor 17 to rotate so that the window segments 18 in the conveyor 17 allocated to the customer order are in front of the operator. The computer also adjusts the aperture width of the shutter mechanism 30 to expose the appropriate number of window segments assigned to the customer order (step 28). This provides clear visual guidance for the operator so that he can quickly and accurately hang each garment in the one of the window segments assigned to the customer order (step 29). This sequence of steps 26-29 can then be repeated for the next garment in the batch, until all of the garments have been sorted.

The above disclosure sets forth a number of embodiments of the present invention described in detail with respect to the accompanying drawings. Those skilled in this art will appreciate that various changes, modifications, other structural arrangements, and other embodiments could be practiced under the teachings of the present invention without departing from the scope of this invention as set forth in the following claims.

I claim:

1. A garment sorting system for a cleaner processing customer orders containing numbers of garments, said system comprising:
a computer storing data for each customer order including identification tag information for each garment in the customer order; and
a sorting station for an operator to manually sort commingled garments from multiple customer orders after cleaning, said sorting station having:
(a) a scanner communicating with the computer for scanning identification tags on garments;
(b) a sorting conveyor for hanging garments movable along a track relative to the sorting station under the control of the computer; and
(c) a shutter mechanism adjacent to the sorting conveyor with an aperture adjustable by the computer to expose a selected section of the sorting conveyor to the operator for hanging garments;
wherein the computer allocates a section of the sorting conveyor for each customer order based on the garments in the customer order; and wherein in response to the scanner scanning the identification tag for a garment, the computer moves the sorting conveyor and adjusts the shutter mechanism to expose the section of the sorting conveyor allocated for the customer order associated with the scanned garment.

2. The garment sorting system of claim 1 wherein the computer allocates the sections of the sorting conveyor based at least in part on the number of garments in each customer order.

3. The garment sorting system of claim 1 wherein the computer allocates the sections of the sorting conveyor based at least in part on the types of garments in each customer order.

4. The garment sorting system of claim 1 wherein sorting conveyor further comprises a connected series of window segments for hanging garments, and wherein the computer allocates a number of contiguous window segments for each customer order.

5. The garment sorting system of claim 1 wherein the shutter mechanism further comprises a fixed first shutter and a second shutter movable parallel to the sorting conveyor under the control of the computer to adjust to the width of the section of the sorting conveyor exposed to the operator.

6. The garment sorting system of claim 1 wherein the computer prints an identification tag for each garment in a customer order prior to cleaning.

7. A method for sorting garments for a cleaner processing customer orders containing numbers of garments, said method comprising:
processing each customer order as it is received by attaching an identification tag to each garment identifying its customer order, and storing data for each customer order including identification tag information for each garment in the customer order;
cleaning commingled garments from a plurality of customer orders;
providing a sorting station for an operator to manually sort commingled garments from multiple customer orders after cleaning, said sorting station having:
(a) a scanner for scanning identification tags on garments;
(b) a sorting conveyor for hanging garments movable along a track relative to the sorting station; and
(c) a shutter mechanism adjacent to the sorting conveyor with an adjustable aperture to expose a selected section of the sorting conveyor to the operator for hanging garments;
allocating a section of the sorting conveyor for each customer order based on the stored data regarding the garments in that customer order;
for each of the commingled garments after cleaning:
(a) scanning the identification tag for the garment to identify its customer order;
(b) moving the sorting conveyor and adjusting the shutter mechanism to expose the section of the sorting conveyor allocated for the customer order associated with the scanned garment; and
(c) hanging the scanned garment on the exposed portion of the sorting conveyor, thereby sorting the commingled garments by their respective customer orders on the sorting conveyor.

8. The method of claim 7 wherein sections of the sorting conveyor are allocated based at least in part on the number of garments in each customer order.

9. The method of claim 7 wherein sections of the sorting conveyor are allocated based at least in part on the types of garments in each customer order.

10. The method of claim 7 wherein the initial processing of each customer order further comprises printing an identification tag for each garment identifying its customer order.
